(19) United States
(12) Patent Application Publication
(10) Pub. No.: US 2023/0409701 A1
(43) Pub. Date: Dec. 21, 2023

(54) ELECTRONIC APPARATUS AND CONTROL METHOD THEREOF

(71) Applicant: SAMSUNG ELECTRONICS CO., LTD., Suwon-si (KR)

(72) Inventor: Grzegorz Pawel GRZESIAK, Warszawa (PL)

(73) Assignee: SAMSUNG ELECTRONICS CO., LTD., Suwon-si (KR)

(21) Appl. No.: 18/199,172

(22) Filed: May 18, 2023

(30) Foreign Application Priority Data
Jun. 15, 2022 (KR) 10-2022-0072726

(51) Int. Cl. G06F 21/55

(52) U.S. Cl. CPC G06F 21/55

(57) ABSTRACT

An electronic apparatus includes a memory storing an artificial intelligence model and at least one processor configured to identify a first activation function used in at least one layer of the artificial intelligence model, obtain a second activation function by adding a first periodic function corresponding to a first time interval to the first activation function, apply the second activation function to an output layer during the first time interval, obtain a third activation function by adding a second periodic function corresponding to a second time interval to the first activation function, and update the artificial intelligence model by applying the third activation function to the output layer during the second time interval.

### CROSS-REFERENCE TO RELATED APPLICATION(S)

This application is based on and claims priority to Korean Patent Application No. 10-2022-0072726, filed on Jun. 15, 2022, in the Korean Intellectual Property Office, the disclosure of which is incorporated herein by reference in its entirety.

### BACKGROUND

### 1. Field

The disclosure relates to an electronic apparatus and a control method thereof. More particularly, the disclosure relates to an electronic apparatus that reinforces security of an artificial intelligence model and a control method thereof.

### 2. Description of Related Art

With developments in electronic technology, electronic devices of various types are being developed and supplied. Specifically, methods of attacking artificial (or neural network) models are also diversifying with the development in artificial intelligence technology. For example, as a method of attacking a neural network model, an adversarial attack may be a method of misleading an artificial intelligence model for a data set to be modified or for a logic corruption to occur such that the neural network model which uses a classification algorithm cannot perform an accurate classification of the data set.

The adversarial attack as described above may be performed by grasping a gradient value of an activation function that is present within at least one layer included in the artificial intelligence model. The gradient value of the activation function may be information which may predict a learning direction of the artificial intelligence model or each layer. Those performing the adversarial attack may be able to grasp, through a minute change in the data set, the gradient value of the activation function included in each layer, predict a learning direction of the artificial intelligence model, and perform the attack by maliciously changing the learning direction through the method above.

In related art, there is a method of encrypting a whole artificial intelligence model or a portion of the layers, but the above-described method requires a large amount of data storage space for encryption, and there is a problem of processing rate decreasing and power consumption increasing due to the encryption.

### SUMMARY

Provided is an electronic apparatus that may reinforce security of an artificial intelligence model by updating an activation function of a trained artificial intelligence model and a control method thereof.

Additional aspects will be set forth in part in the description which follows and, in part, will be apparent from the description, or may be learned by practice of the presented embodiments.

According to an aspect of the disclosure, an electronic apparatus may include a memory storing an artificial intelligence model and at least one processor configured to identify a first activation function used in at least one layer of the artificial intelligence model, obtain a second activation function by adding a first periodic function corresponding to a first time interval to the first activation function, apply the second activation function to an output layer during the first time interval, obtain a third activation function by adding a second periodic function corresponding to a second time interval to the first activation function, and update the artificial intelligence model by applying the third activation function to the output layer during the second time interval.

Each of the first periodic function and the second periodic function may include functions added to a plurality of periodic functions, the first periodic function may include at least one of a period of a function, an amplitude of a function, and a number of periodic functions, and the second periodic function may include at least one of a period of a function, an amplitude of a function, and a number of periodic functions that is different from the first periodic function.

The electronic apparatus may include a communication interface, and the at least one processor may be configured to obtain the first periodic function corresponding to the first time interval from an external device through the communication interface and obtain the second periodic function corresponding to the second time interval from the external device through the communication interface.

The at least one processor may be configured to identify whether there is an attack on the updated artificial intelligence model based on a pixel value change rate of an image output from the updated artificial intelligence model.

The at least one processor may be further configured to update the artificial intelligence model by training the at least one layer having the second activation function or the third activation function applied thereto and additionally training all layers of the artificial intelligence model.

The electronic apparatus may be implemented as a low-capacity device in which the at least one layer of the artificial intelligence model is not encrypted.

The at least one processor may be configured to obtain the first periodic function and the second periodic function based on a type of the artificial intelligence model, a type of the at least one layer, a type of the electronic apparatus, a user of the electronic apparatus, or a type of the first activation function.

The at least one layer may include the output layer.

The first activation function may include at least one of a continuous function and a discontinuous function.

According to an aspect of the disclosure, a control method of an electronic apparatus may include identifying a first activation function used in at least one layer of an artificial intelligence model, obtaining a second activation function by adding a first periodic function corresponding to a first time interval to the first activation function, applying the second activation function to an output layer during the first time interval, obtaining a third activation function by adding a second periodic function corresponding to a second time interval to the first activation function, and updating the artificial intelligence model by applying the third activation function to the output layer during the second time interval.

Each of the first periodic function and the second periodic function may include functions added to a plurality of periodic functions, the first periodic function may include at least one of a period of a function, an amplitude of a function, and a number of periodic functions, and the second periodic function may include at least one of a period of a function, an amplitude of a function, and a number of periodic functions that is different from the first periodic function.

The method may include obtaining the first periodic function corresponding to the first time interval from an external device through a communication interface and obtaining the second periodic function corresponding to the second time interval from the external device through the communication interface.

The method may include identifying whether there is an attack on the updated artificial intelligence model based on a pixel value change ratio of an image output from the updated artificial intelligence model.

The method may include, based on the artificial intelligence model being updated, training the at least one layer having the second activation function or the third activation function applied thereto, or additionally training all layers of the artificial intelligence model.

The electronic apparatus may be implemented as a low-capacity device in which the at least one layer of the artificial intelligence model is not encrypted.

The method may include obtaining the first periodic function and the second periodic function based on a type of the artificial intelligence model, a type of the at least one layer, a type of the electronic apparatus, a user of the electronic apparatus, or a type of the first activation function.

The at least one layer may include the output layer.

The first activation function may include at least one of a continuous function and a discontinuous function.

According to an aspect of the disclosure, a non-transitory computer-readable storage medium may store instructions that, when executed by a processor of an electronic apparatus, cause the processor to identify a first activation function used in at least one layer of an artificial intelligence model, obtain a second activation function by adding a first periodic function corresponding to a first time interval to the first activation function, apply the second activation function to an output layer during the first time interval, obtain a third activation function by adding a second periodic function corresponding to a second time interval to the first activation function, and update the artificial intelligence model by applying the third activation function to the output layer during the second time interval.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a method of updating an artificial intelligence model according to an embodiment;

FIG. 2 is a diagram illustrating a configuration of an electronic apparatus according to an embodiment;

FIGS. 3A, 3B, 3C and 3D are diagrams illustrating a method of updating an activation function according to an embodiment;

FIG. 4A and FIG. 4B are diagrams illustrating a method of retraining an artificial intelligence model according to an embodiment;

FIG. 5A is a diagram illustrating an output of an updated artificial intelligence model according to an embodiment;

FIG. 5B and FIG. 5C are diagrams illustrating a change in an output image based on a pixel change ratio according to an embodiment;

FIGS. 6A, 6B and 6C are diagrams illustrating a performance of an artificial intelligence model based on an activation function according to an embodiment;

FIG. 7 is a diagram illustrating a detailed configuration of an electronic apparatus according to an embodiment; and

FIG. 8 is a flowchart illustrating a control method of an electronic apparatus according to an embodiment.

### DETAILED DESCRIPTION

Hereinafter, embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Terms used in the disclosure will be briefly described, and the disclosure will be described in detail.

The terms used in describing the various embodiments of the disclosure are general terms selected that are currently widely used considering their function herein. However, the terms may change depending on intention, legal or technical interpretation, emergence of new technologies, and the like of those skilled. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have,” “may have,” “include,” “may include,” or the like are used to designate a presence of a corresponding characteristic (e.g., elements such as numerical value, function, operation, or component), and not to preclude a presence or a possibility of additional characteristics.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Expressions such as “first,” “second,” “1st,” “2nd,” and so on used herein may be used to refer to various elements regardless of order and/or importance. Further, it should be noted that the expressions are merely used to distinguish an element from another element and not to limit the relevant elements.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with a hardware or software, or implemented with a combination of hardware and software. Further, a plurality of “modules” or a plurality of “parts,” except for a “module” or a “part” which needs to be implemented to a specific hardware, may be integrated to at least one module and implemented in at least one processor.

In addition, a deep neural network (DNN) in the disclosure may be a representative example of an artificial neural network model simulating brain nerves, and is not limited to an artificial neural network model that uses a specific algorithm.

In addition, a ‘parameter’ in the disclosure may be a value used in an operation process of each layer forming a neural network, and for example, may include a weight value which is used when applying an input value to a predetermined formula. In addition, the parameter may be expressed in a matrix form. The parameter may be a value set as a result of training, and may be updated through a separate training data when necessary.

Embodiments of the disclosure will be described in greater detail below with reference to the accompanied drawings.

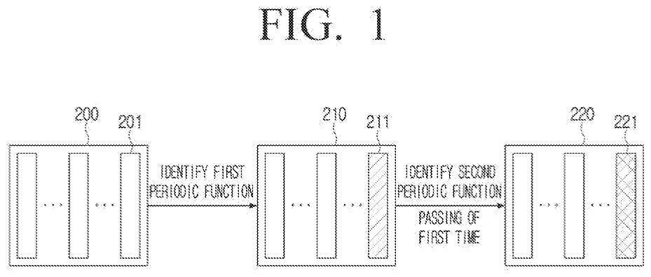

FIG. 1 is a diagram illustrating a method of updating an artificial intelligence model according to an embodiment.

The electronic apparatus according to an embodiment may include an artificial intelligence model (or artificial neural network model or learning network model) formed of at least one neural network layer. The artificial neural network may include the DNN, and examples thereof may include a convolutional neural network (CNN), a recurrent neural network (RNN), a restricted boltzmann machine (RBM), a deep belief network (DBN), a bidirectional recurrent deep neural network (BRDNN), a Deep-Q Networks, or the like, but the embodiment is not limited to the above-described examples.

Referring to FIG. 1, an electronic apparatus 100 according to an embodiment may include an artificial intelligence model 200 formed of at least one layer (e.g., a plurality of layers). In this case, each layer may include an activation function. The activation function may be a function that converts a weighted sum obtained as a result of performing operation to an output signal (or, data) when operation of an input data is performed within the layer.

According to an embodiment, the electronic apparatus 100 may be implemented as a low-capacity device. In this case, the at least one layer from among the plurality of layers included in the artificial intelligence model 200 may not be encrypted for reasons such as lack of memory, and the like. Accordingly, the electronic apparatus 100 may defend against an external attack on the artificial intelligence model by reinforcing security by periodically updating the activation function (or, base activation function) that is used in the at least one layer from among the plurality of layers included in the artificial intelligence model 200. Specifically, the electronic apparatus 100 may update the activation function by applying a periodic function which is different for each pre-set time interval to the activation function that is used in the at least one layer included in the artificial intelligence model 200.

For example, as shown in FIG. 1, the initial artificial intelligence model 200 may include an output layer. A first periodic function may be added to the activation function to update the activation function, and the artificial intelligence model 200 may be updated to artificial intelligence model 210 with a trained output layer 211. A second periodic function may be added to the activation function after a pre-determined time has passed to update the activation function, and the artificial intelligence model 210 may be updated to artificial intelligence model 220 with a trained output layer 221.

Various embodiments of reinforcing security of the artificial intelligence model by periodically updating the activation function of the artificial intelligence model will be described below.

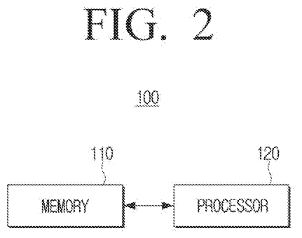

FIG. 2 is a diagram illustrating a configuration of an electronic apparatus according to an embodiment.

Referring to FIG. 2, the electronic apparatus 100 may include a memory 110 and a processor 120.

The electronic apparatus 100 may be implemented as a device of various types that may provide content such as a server (e.g., a content providing server, a personal computer (PC), etc.). Alternatively, the electronic apparatus 100 may be a system itself in which a cloud computing environment is built. However, the embodiment is not limited thereto, and the electronic apparatus 100 may be applicable without limitation so long as it is a device that processes data by using the artificial intelligence model such as a television (TV), a set-top box, a tablet PC, a mobile phone, a desktop PC, a laptop PC, a netbook computer, or the like.

According to an example, the electronic apparatus 100 may be implemented as a low-capacity device in which the at least one layer included in the artificial intelligence model 200 is not encrypted. For example, if the plurality of layers is present in the artificial intelligence model 200 within the electronic apparatus 100, only a portion of the layers from among the plurality of layers may be encrypted. In another example, all of the plurality of layers in the artificial intelligence model 200 within the electronic apparatus 100 may be unencrypted.

The memory 110 may store data necessary for the various embodiments of the disclosure. The memory 110 may be implemented in an embedded memory form in the electronic apparatus 100 according to a data storage use, or implemented in an attachable or detachable memory form in the electronic apparatus 100. For example, data for the driving of the electronic apparatus 100 may be stored in a memory embedded to the electronic apparatus 100, and data for an expansion function of the electronic apparatus 100 may be stored in a memory attachable to and detachable from the electronic apparatus 100. The memory embedded in the electronic apparatus 100 may be implemented as at least one from among a volatile memory (e.g., a dynamic random access memory (DRAM), a static RAM (SRAM), or a synchronous dynamic RAM (SDRAM)), or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). In the case of the memory attachable to and detachable from the electronic apparatus 100, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a universal serial bus (USB) memory) connectable to a USB port, or the like.

According to an example, the memory 110 may store at least one instruction for controlling the electronic apparatus 100 or a computer program that includes instructions.

According to another example, the memory 110 may store information about a trained artificial intelligence (or artificial intelligence) model including the plurality of layers. The storing information about the artificial intelligence model may refer to storing various information associated with an operation of the artificial intelligence model, for example, information about the plurality of layers included in the artificial intelligence model, information about a parameter, a bias, or the like used in each layer, and the like. However, the information about the artificial intelligence model may be stored in the memory inside the processor 120 according to an implementation of the processor 120 which will be described below. For example, if the processor 120 is implemented as a dedicated hardware, the information about the artificial intelligence model may be stored in the memory inside the processor 120.

At least one processor 120 (hereinafter, referred to as a ‘processor’) may control the overall operation of the electronic apparatus 100 by being electrically connected with the memory 110. The processor 120 may be formed of one or a plurality of processors. Specifically, the processor 120 may perform, by executing the at least one instruction stored in the memory 110, an operation of the electronic apparatus 100 according to the various embodiments of the disclosure.

According to an embodiment, the processor 120 may be implemented as a digital signal processor (DSP) for processing a digital image signal, a microprocessor, a graphics processing unit (GPU), an artificial intelligence (AI) processor, a neural processing unit (NPU), or a time controller (TCON). However, the embodiment is not limited thereto, and may include one or more from among a central processing unit (CPU), a micro controller unit (MCU), a micro processing unit (MPU), a controller, an application processor (AP), a communication processor (CP), or an ARM processor, or may be defined by the corresponding term. In addition, the processor 120 may be implemented as a System on Chip (SoC) or a large scale integration (LSI) in which a processing algorithm is embedded, and may be implemented in the form of an application specific integrated circuit (ASIC) or a field programmable gate array (FPGA).

In addition, the processor 120 for executing the artificial intelligence model (or, neural network model) according to an embodiment may be implemented through a combination of a generic-purpose processor such as the CPU, the AP, the DSP or the like, a graphics dedicated processor such as the GPU, or a vision processing unit (VPU), or an artificial intelligence dedicated processor such as the NPU and a software.

The processor 120 may control to process input data according to a pre-defined operation rule or a neural network model stored in the memory 110. Alternatively, if the processor 120 is a dedicated processor (or artificial intelligence dedicated processor), it may be designed in a hardware structure that specializes in the processing of a specific artificial intelligence model. For example, the hardware specializing in the processing of the specific artificial intelligence model may be designed as a hardware chip such as, for example, and without limitation, the ASIC, FPGA, and the like. If the processor 120 is implemented as a dedicated processor, it may be implemented to include the memory for realizing the embodiment of the disclosure, or implemented to include a memory processing function for using the external memory.

According to an embodiment, the processor 120 may identify a base activation function that is used in the at least one layer included in the artificial intelligence model. According to an example, the artificial intelligence model 200 may perform operations using activation functions of various types that include continuous functions such as an Identity Function, a Logistic Sigmoid Function, and a Hyperbolic Tangent (tanh) Function or discontinuous functions such as a rectified linear unit (ReLU) Function, and a Leaky ReLU Function, and the processor 120 may identify the base activation function included in the artificial intelligence model 200. The base activation function may be a function prior to the activation function being updated, and may be, for example, the Logistic Sigmoid Function, the Hyperbolic Tangent (tanh) Function, the ReLU Function, or the Leaky ReLU Function, but is not limited thereto.

Then, the processor 120 according to an embodiment may identify a first periodic function for updating the activation function that is used in the at least one layer in the artificial intelligence model 200. The first periodic function may include at least one periodic function. For example, the first periodic function may be a function operated according to at least one from among four fundamental arithmetic operations. Specifically, it may be a function added with a plurality of periodic functions, and the periodic function may be trigonometric functions such as, for example, a Sine function or a Cosine function, but is not limited thereto.

According to an example, the processor 120 may identify the first periodic function based on information associated with the first periodic function. The information associated with the first periodic function may include an amplitude of the function, a period of the function, a number of periodic functions included in the function, and the like, and the information associated with the first periodic function may be identified based on context information of the electronic apparatus 100. The context information of the electronic apparatus 100 may include various information associated with the electronic apparatus 100 such as, for example, and without limitation, attribute information, user information, and the like of the electronic apparatus 100. In an example, the processor 120 may identify the first periodic function in a form same as Equation (1) below:

10⁽⁻⁵⁾×(sin3x+sin2x+sinx) (1)

where x represents time.

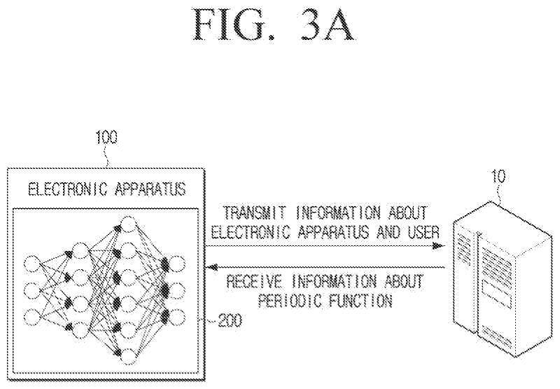

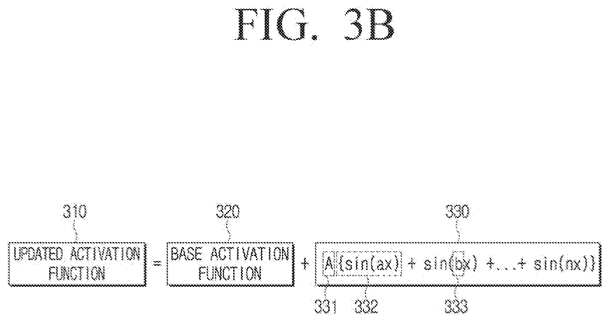

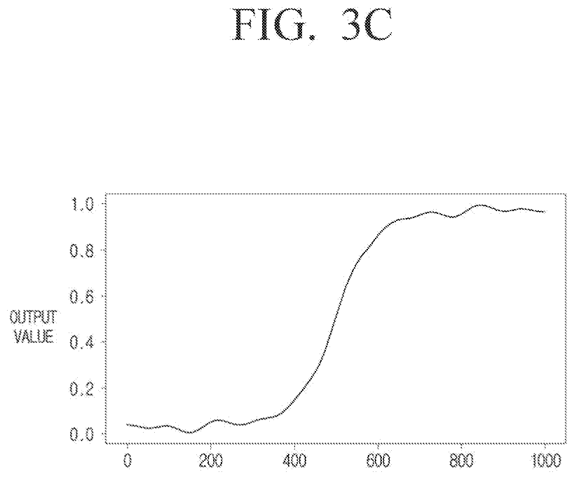

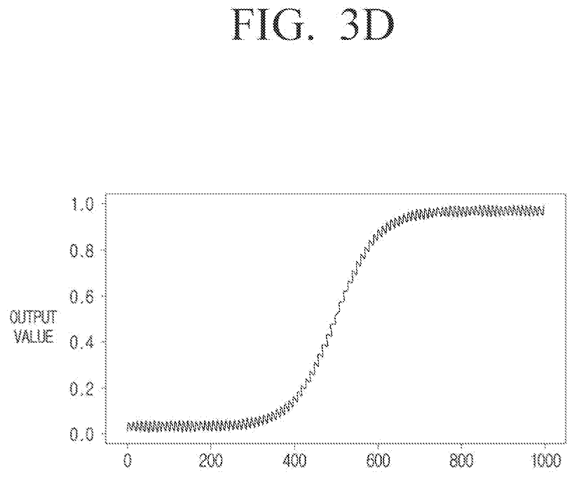

According to an example, the processor 120 may obtain, from an external device, information about the first periodic function (at least one from among the amplitude of the first periodic function, the period of the first periodic function, and the number of periodic functions included in the first periodic function) through a communication interface. A detailed method on obtaining the first periodic function will be described in detail through FIG. 3A to FIG. 3D.

Then, the processor 120 according to an embodiment may obtain a first activation function updated by adding the first periodic function to the base activation function (e.g., Logistic Sigmoid Function or ReLU Function), and obtain an updated artificial intelligence model 200 by applying the above to the at least one layer included in the artificial intelligence model 200. According to an example, the processor 120 may obtain the first activation function as Equation (2) below by adding the first periodic function to the Logistic Sigmoid Function identified as the activation function.

Sigmoid(x)+10⁽⁻⁵⁾×(sin3x+sin2x+sinx) (2)

The layer with the updated activation function according to an example may be an output layer, but is not necessarily limited thereto.

In this case, the processor 120 according to an embodiment may apply the first periodic function during a first time interval, and apply the activation function different from the first activation function to the at least one layer after the first time interval. In other words, the artificial intelligence model 200 having the the updated first activation function applied thereto may be updated to the artificial intelligence model 200 having the activation function different from the first activation function applied thereto after the first time interval has passed.

The processor 120 according to an embodiment may identify a time interval corresponding from a time point at which the first activation function is applied to a pre-set time (e.g., 7 days) as the first time interval. The pre-set time may be a value stored at an initial setting, but is not limited thereto, and may be set and changed according to a user command. Alternatively, the pre-set time may be set automatically based on the context information of the electronic apparatus 100, for example, a type of device, user information, a user history, and the like, of the electronic apparatus 100. According to another example, the first time interval may be a time interval corresponding from a time point at which at least one training is completed after the artificial intelligence model 200 is updated based on the first activation function being applied to a pre-set time.

According to an embodiment, the processor 120 may update the activation function based on the activation function and the second periodic function used in the at least one layer included in the artificial intelligence model 200, and obtain the updated artificial intelligence model 200 by applying the above to the at least one layer included in the artificial intelligence model 200.

The processor 120 according to an embodiment may identify the second periodic function different from the first periodic function, and obtain a second activation function updated by adding the identified second periodic function to the identified base activation function. The second periodic function may be a function added with the plurality of periodic functions, and the processor 120 according to an example may identify a function in which at least one from among the period, the amplitude and the number of periodic functions included in the function is different from the first periodic function as the second periodic function.

For example, the processor 120 may identify the second periodic function as Equation (3) below, and obtain the second activation function updated as Equation (4) below by adding the second periodic function to the base activation function (e.g., Logistic Sigmoid Function).

10⁽⁻⁷⁾×(sin90x+sin60x+sin30x) (3)

Sigmoid(x)+10⁽⁻⁷⁾×(sin90x+sin60x+sin30x) (4)

Then, according to an embodiment, the processor 120 may obtain, based on a first time being identified as having passed from the time point at which the updated first activation function is applied, the updated artificial intelligence model 200 by applying the second activation function to the at least one layer (e.g., output layer).

Then, the processor 120 may update the artificial intelligence model by applying the activation function different from the second activation function to the at least one layer after a second time interval.

Accordingly, the electronic apparatus 100 may reinforce security as the activation function obtains the updated artificial intelligence model 200 periodically, and the activation function of the artificial intelligence model 200 becomes difficult to analyze externally.

FIGS. 3A, 3B, 3C and 3D are diagrams illustrating a method of updating an activation function according to an embodiment.

The processor 120 according to an embodiment may receive information about the periodic function from an external device 10 through the communication interface, and update the activation function used in the artificial intelligence model 200 based on the received information.

According to FIG. 3A, the processor 120 of the electronic apparatus 100 according to an example may transmit the context information of the electronic apparatus 100 to the external device 10 through the communication interface, and then update, when the information about the periodic function is received from the external device 10, the activation function based therefrom. The context information of the electronic apparatus 100 may include at least one from among information about the artificial intelligence model 200, and the attribute information, the user information, and the use history information of the electronic apparatus 100.

For example, the information about the artificial intelligence model 200 may include at least one from among information about a type of the artificial intelligence model 200, a type of at least one layer included in the artificial intelligence model 200, or a type of the activation function included in the artificial intelligence model 200. The type of the layer, for example, the layer to which the activation function to be updated is to be applied, may be one from among an input layer, a hidden layer, or an output layer. The attribute information of the electronic apparatus 100 may include at least one from among type information of the electronic apparatus 100, and a model name, a device serial number, or manufacturer information of the electronic apparatus 100. The user information may include identification information, profile information, and the like of the user of the electronic apparatus 100. The identification information of the user may include user certification information (e.g., ID information). The use history information may include information such as, for example, and without limitation, a total time of use, an interval between uses, a time slot of use, use data, and the like of the electronic apparatus 100.

The external device 10 may be implemented as a server or a device of various types that stores and manages data such as, for example, and without limitation, a data providing server, a PC, and the like. Alternatively, the external device 10 may be a system itself with a cloud computing environment built therein, but is not limited thereto. For example, the external device 10 may be a server that stores and manages a look-up table with information about the periodic function corresponding to the context information of the electronic apparatus 100 mapped therein. The information about the periodic function may include information about the period and amplitude of the periodic function, and the number of periodic functions, and the above will be described in detail through FIG. 3B.

Referring to FIG. 3B, the processor 120 according to an embodiment may obtain an updated activation function 310 by adding a first periodic function 330 to a base activation function 320. The base activation function may be the function prior to the activation function being updated, and may be, for example, the Logistic Sigmoid Function, the Hyperbolic Tangent (tanh) Function, the ReLU Function, or the Leaky ReLU Function, but is not limited thereto.

According to an example, the processor 120 may first identify the activation function 320 that is used in the at least one layer (e.g., output layer) included in the artificial intelligence model 200.

Then, the processor 120 according to an example may identify the first periodic function 330 corresponding to information about an amplitude of the periodic function 331, a period of the periodic function 333, and a number of periodic functions 332 included in the information about the periodic function received from the external device 10. For example, if the processor 120 transmits user identification information to the external device 10 through the communication interface, the external device 10 may transmit the information about the periodic function corresponding thereto to the electronic apparatus 100. The processor 120 may be able to identify, based on the received information about the first periodic function being the amplitude=(10⁻⁶), the period=(3,2,1), and the number of functions being 3, the first periodic function 330 as Equation (5) below based therefrom.

10⁽⁻⁶⁾×(sin3x+sin2x+sinx) (5)

According to another example, the processor 120 may obtain the first periodic function 330 from the external device 10. For example, the processor 120 may obtain the first periodic function itself (10⁽⁻⁶⁾×(sin3x+sin2x+Sinx)) from the external device 10 when the user identification information is transmitted to the external device 10.

Then, the processor 120 according to an example may obtain the updated activation function by adding the identified activation function 320 and the identified first periodic function 330. For example, FIG. 3C and FIG. 3D are graphs of the activation function added with the periodic function, and a shape of the graph may vary according to the information about the periodic function, for example, the amplitude, the period, and the number of periodic function.

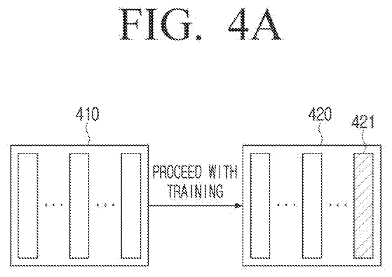

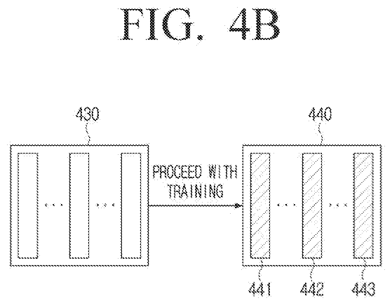

FIG. 4A and FIG. 4B are diagrams illustrating a method of retraining an artificial intelligence model according to an embodiment.

According to an embodiment, the artificial intelligence model (or, neural network model) stored in the memory 110 may be created through learning. The being created through learning refers to a pre-defined operation rule or an artificial intelligence model being created to perform a desired feature (or, purpose) because a basic artificial intelligence model is trained by a learning algorithm using a plurality of learning data. The learning may be carried out through a separate server and/or system according to the disclosure, but is not limited thereto, and may be carried in the electronic apparatus 100. Examples of the learning algorithm may include an unsupervised learning, a semi-supervised learning, or a reinforcement learning, but is not limited to the above-described examples.

Referring to FIG. 4A, according to an embodiment, the processor 120 may additionally train at least one layer having the updated activation function applied thereto when an artificial intelligence model 410 stored in the memory 110 is updated.

According to an example, when the activation function of the output layer from among the plurality of layers included in the artificial intelligence model 410 is updated as the first activation function of the number the periodic function, the processor 120 may proceed with additional training for only the output player with the activation function updated from among the plurality of layers. Accordingly, the processor 120 may be able to obtain an artificial intelligence model 420 that includes a trained output layer 421.

Referring to FIG. 4B, according to an embodiment, the processor 120 may additionally train all layers included in an artificial intelligence model 430 when the artificial intelligence model 430 stored in the memory 110 is updated.

According to an example, when the activation function of the output layer from among the plurality of layers included in the artificial intelligence model 430 is updated as the first activation function of the number the periodic function, the processor 120 may proceed with additional training for all layers included in the artificial intelligence model 430. Accordingly, the processor 120 may be able to obtain an artificial intelligence model 440 with all layers 441, . . . , 442, . . . , 443 trained. The processor 120 may not proceed with a separate additional training even if the at least one layer included in the artificial intelligence model 200 is updated.

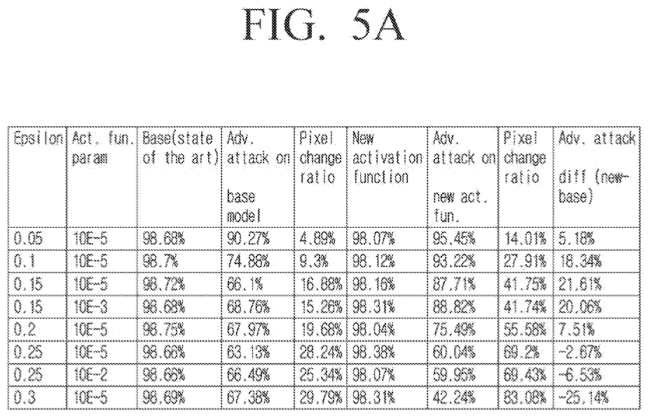

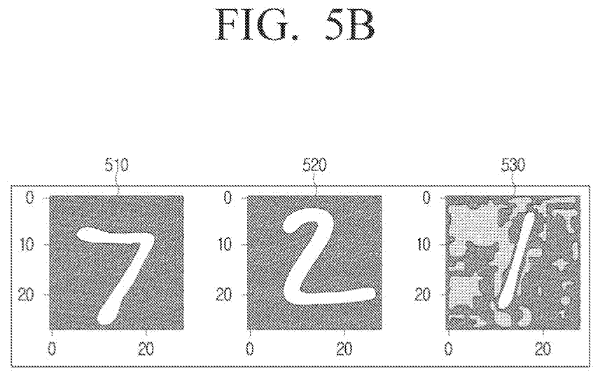

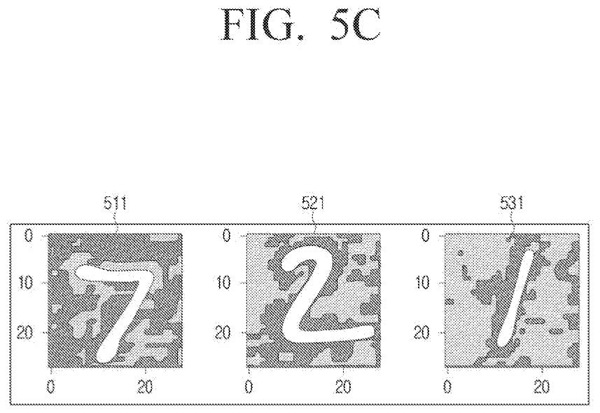

FIG. 5A is a diagram illustrating an output of an updated artificial intelligence model according to an embodiment.

Referring to FIG. 5A, first, an Epsilon may be a size of a parameter that represents a relative intensity of an adversarial attack. A degree to which it affects an image as the size of the Epsilon increases, for example, a number of pixels changed within the image or a degree of size change of the pixel value may be great. For the adversarial attack to be successful, a person should not be aware of the adversarial attack, and the adversarial attack must not be detected by a program that protects a network in which the artificial intelligence model 200 is included.

“Act. fun. param” may refer to a size of the amplitude of the periodic function included in the updated activation function, and “Base (state of the art)” and “New activation function” may refer to a result that correctly classified a test data set (10000 number images) of a base activation function and an updated activation function, respectively. That is, it may refer to a ratio of a correctly classified data. “Adv. attack on base model” and “Adv. attack on new act. fun” may respectively refer to a classification result value after the adversarial attack. Referring to FIG. 5A, a size of the classification result value after the adversarial attack is reduced compared to prior to the adversarial attack. For example, if the Epsilon is 0.1, the classification result value of the base activation function is reduced from 98.7% to 74.88%. In another example, if the Epsilon is 0.1, the classification result value of the updated activation function is reduced from 98.12% to 93.22%. If the Epsilon value is less than or equal to 0.2, the classification result value of the updated activation function is greater than the classification result value of the base activation function after the adversarial attack. “Pixel change ratio” may refer to a pixel change ratio. The higher the pixel change ratio means that a ratio of an image that received an attack is higher, and as the pixel change ratio is higher, a user may easily identify the image that received the attack.

According to an embodiment, the processor 120 may identify whether there is an attack on the updated artificial intelligence model 200 based on a change ratio of a pixel value of an image output from the updated artificial intelligence model 200. For example, the processor 120 may identify, based on a change ratio of an pixel value (or, pixel change ratio) of an output image being identified as greater than or equal to a pre-set value (e.g., 50%), as the output image having been attacked. However, the embodiment is not limited thereto, and the pre-se value may be changed according to a stored value at an initial setting or a user input thereafter. Referring to FIG. 5A, the processor 120 according to an example may identify the output image as the image that has received an attack based on the pixel change ratio being greater than or equal to 69% when the Epsilon value is greater than or equal to 0.25.

Accordingly, the updated artificial intelligence model 200 may be able to identify that the output image is the image that received the attack despite the classification result value being relatively higher compared with prior to the update when the Epsilon value is less than 0.25, and the classification result value being relatively lower compared with prior to the update when the Epsilon value is greater than or equal to 0.25. Accordingly, the artificial intelligence model 200 may receive protection from the adversarial attack as the activation function included in the artificial intelligence model 200 is updated.

FIG. 5B and FIG. 5C are diagrams illustrating a change in an output image based on a pixel change ratio according to an embodiment.

FIG. 5B depicts output images 510 to 530 after an artificial intelligence model of the number the base activation function has received an adversarial attack. The plurality of output images may respectively refer to an image 510 of the number 7, an image 520 of the number 2, and an image 530 of the number 1. An average pixel change ratio of the plurality of images 510 to 530 that received the adversarial attack may be 9.65%, and accordingly, the electronic apparatus 100 may not identify the attack despite having received the adversarial attack.

FIG. 5C depicts output images 511 to 531 after an artificial intelligence model of the number the updated activation function has received an adversarial attack. The plurality of output images may respectively refer to an image 511 of the number 7, an image 521 of the number 2, and an image 531 of the number 1. In this case, the average pixel change ratio of the plurality of images 511 to 531 that received the adversarial attack may be 55.3%, and the processor 120 according to an example may identify the artificial intelligence model 200 as having received the adversarial attack based on the pixel change ratio being greater than or equal to the pre-set value (e.g., 50%).

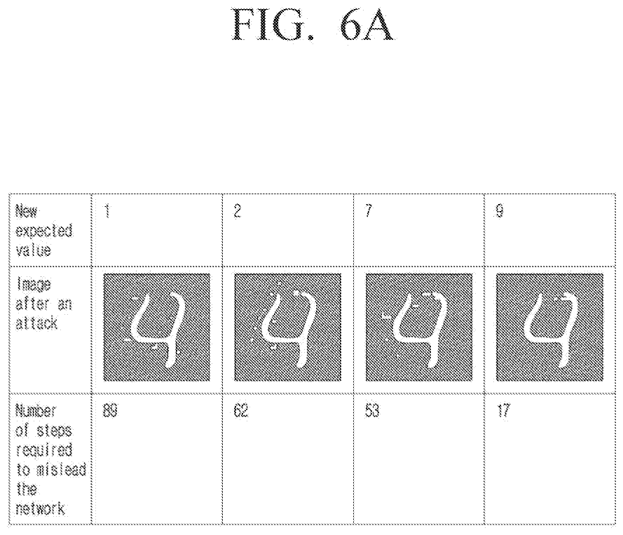

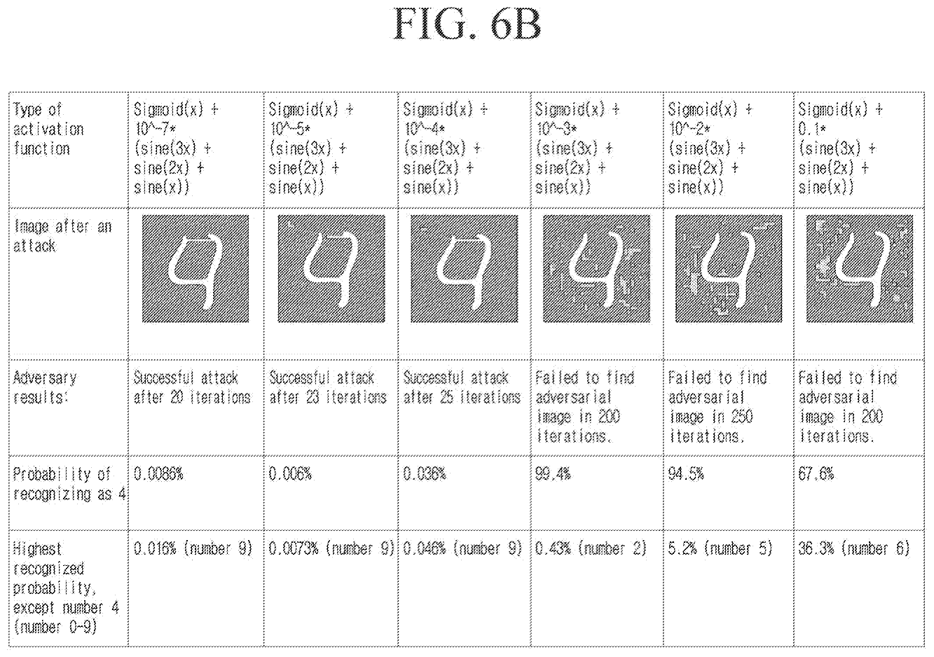

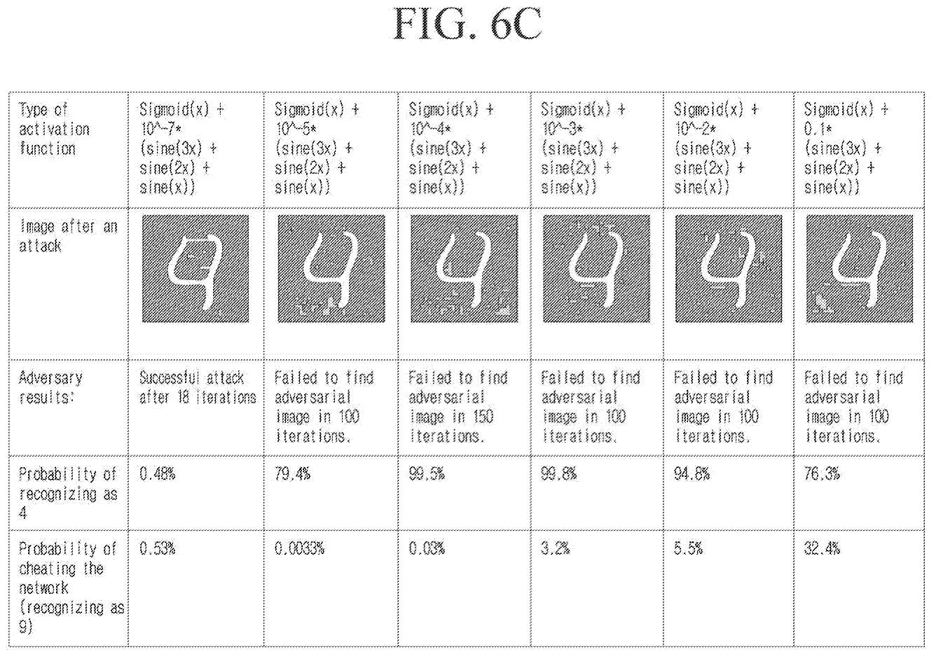

FIGS. 6A, 6B and 6C are diagrams illustrating a performance of an artificial intelligence model based on an activation function according to an embodiment.

FIG. 6A is a table showing output images after the artificial intelligence model of the number the base activation function received an adversarial attack and result values corresponding thereto. An input image may be an image of the number 4, and prior to the adversarial attack, the input image may be classified as 4. A “new expected value” may refer to an expected output value of the input image, that is, an expected value for which number it is to be classified. An “Image after an attack” may refer to an output image after having received the adversarial attack. A “Number of steps required to mislead the network” may refer to a number of times of receiving an attack until the artificial intelligence model outputs an incorrect classification result value. Referring to FIG. 6A, an adversarial attack may be carried out upon the artificial intelligence model by 89 times (or steps), 62 times, 53 times, and 17 times, respectively, until the output image corresponding to input image of the number 4 is incorrectly classified as 1, 2, 7, and 8.

Referring to FIG. 6B and FIG. 6C, a performance according to the size of the amplitude and size of the period of the periodic function included in the updated activation function may be compared.

First, a “Type of activation function” may refer to a type of the updated activation function. An “Image after an attack” represents an output image after having received an adversarial attack. An “Adversary results” may refer to a number of adversarial attacks. A “Probability of recognizing as 4” may refer to a probability of classifying the input image as including the number 4. A “Highest recognized probability except number 4 (number 0-9)” may refer to a number with a highest probability of being recognized from among numbers other than the number 4 and a probability corresponding thereto.

In the case of FIG. 6A, the number of attacks for being recognized as another number may be less than 100 times (or iterations), but in the case of FIG. 6B and FIG. 6C, the number of attacks for the adversarial attack to succeed may be greater than or equal to 100 times, and the processor 120 according to an embodiment may identify the type of the updated activation function, the number of adversarial attacks corresponding thereto, and the amplitude and period of the periodic function based on the probability of it being correctly classified. In this case, the type of the updated activation function, the number of adversarial attacks corresponding thereto, and the amplitude and period of the periodic function corresponding to the probability of it being correctly classified according to an example may be pre-stored in a memory in the external device 10.

According to an example, the processor 120 may transmit a signal for identifying the type of the activation function, in which the number of attacks for the adversarial attack to succeed is greater than or equal to a pre-set value (e.g., 200 times) and the probability of being correctly classified is greater than or equal to a pre-set value (e.g., 90%), to the external device 10. Then, when information about the periodic function corresponding thereto is received from the external device 10, the processor 120 according to an example may obtain an activation function which includes a plurality of periodic functions in which the amplitude is 10\hat{ }−3 and the period is respectively 3, 2, and 1 as the activation function corresponding thereto. Alternatively, an activation function which includes the plurality of periodic functions in which the amplitude is 10\hat{ }−2 and the period is respectively 3, 2, and 1 as the activation function corresponding thereto may also be obtained. The above may be identified through the table in FIG. 6B.

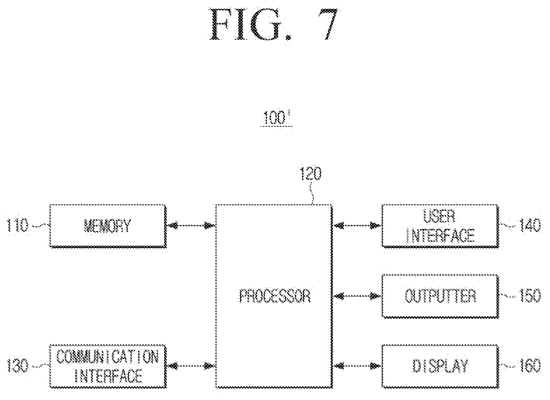

FIG. 7 is a diagram illustrating a detailed configuration of an electronic apparatus according to an embodiment.

Referring to FIG. 7, an electronic apparatus 100′ may include the memory 110, the processor 120, a communication interface 130, a user interface 140, an outputter 150, and a display 160. Detailed descriptions on the configurations that overlap with the configurations shown in FIG. 2 from among the configurations shown in FIG. 7 will be omitted.

The communication interface 130 may receive content of various types. For example, the communication interface 130 may receive a signal in a streaming or downloading method from an external device (e.g., source device) an external storage medium (e.g., USB memory), an external server (e.g., WEBHARD), or the like through communication methods such as, for example, and without limitation, an AP based Wi-Fi (e.g., Wi-Fi, wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

According to an embodiment, the processor 120 may obtain the first periodic function corresponding to the first time interval and the second periodic function corresponding to the second time interval from an external device through the communication interface 130, and update the activation function using the obtained first periodic function and the second periodic function.

The user interface 140 may be implemented as a device such as a button, a touch pad, a mouse, and a keyboard, or implemented as a touch screen, a remote controller transceiver, and the like capable of performing the above-described display function and an operation input function together. The remote controller transceiver may receive a remote controller signal from an external remote controlling device or transmit the remote controller signal through at least one communication method from among an infrared communication, a Bluetooth communication, or a Wi-Fi communication.

The outputter 150 may output a sound signal. For example, the outputter 150 may convert and amplify a digital sound signal processed in the processor 120 to an analog sound signal and output the same. For example, the outputter 150 may include at least one speaker unit, a digital/analog (D/A) converter, an audio amplifier, and the like, which may output at least one channel. The outputter 150 according to an example may be realized to output various multi-channel sound signals. In this case, the processor 120 may control the outputter 150 to enhance process and output a sound signal input to correspond to an enhance processing of an input image. For example, the processor 120 may convert an input 2-channel sound signal to a virtual multi-channel (e.g., 5.1-channel) sound signal, recognize a location at which the electronic apparatus 100′ is placed and process as a space optimized stereo sound signal, or provide an optimized sound signal according to a type of the input image (e.g., content genre).

The display 160 may be implemented as a display that includes a self-emissive element, or implemented as a display that includes non-emissive element and a backlight. For example, the display may be implemented as a display of various types such as, for example, and without limitation, a liquid crystal display (LCD), an organic light emitting diode (OLED) display, a light emitting diodes (LED), a micro LED, a mini LED, a plasma display panel (PDP), a quantum dot (QD) display, a quantum dot light emitting diodes (QLED), or the like. In the display 160, a driving circuit, which may be implemented in the form of an a-si TFT, a low temperature poly silicon (LTPS) TFT, an organic TFT (OTFT), or the like, a backlight unit, and the like may be included. The display 160 may be implemented as a touch screen coupled with a touch sensor, a flexible display, a rollable display, a three-dimensional display (3D display), a display physically coupled with a plurality of display modules, or the like. The processor 120 may control the display 160 to output the output image obtained according to the various embodiments described above. The output image may be a high-resolution image greater than or equal to 4K or 8K.

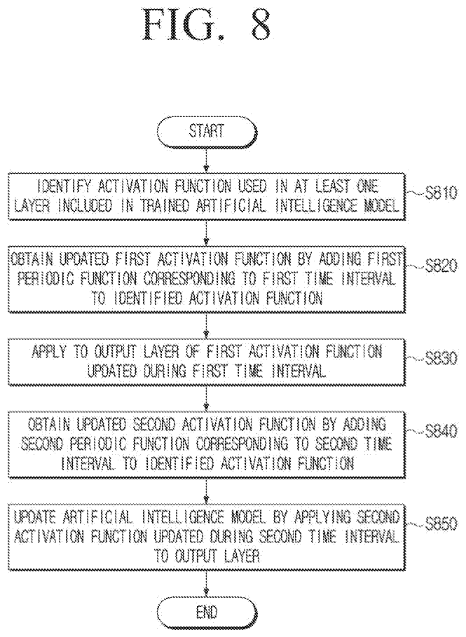

FIG. 8 is a flowchart illustrating a control method of an electronic apparatus according to an embodiment.

According to a control method of the electronic apparatus that stores information about the artificial intelligence model that includes the plurality of layers shown in FIG. 8. In operation S810, the activation function (e.g., a first activation function) used in the at least one layer included in the trained artificial intelligence model may be identified. The at least one layer may include the output layer. In addition, the activation function may include at least one from among a continuous function or a discontinuous function.

In operation S820, the updated first activation function (e.g., a second activation function) may be obtained by adding the first periodic function corresponding to the first time interval to the identified activation function.

In operation S830, the first activation function updated during the first time interval may be applied to the output layer.

In operation S840, the updated second activation function (e.g., a third activation function) may be obtained by adding the second periodic function corresponding to the second time interval to the identified activation function. In operation S850, the artificial intelligence model may be updated by applying the second activation function updated during the second time interval to the output layer (S850).

The first periodic function and the second periodic function may be functions added to the plurality of periodic functions, and at least one of the period of function, the amplitude of the function, and the number of periodic functions included in the functions may vary.

In addition, the control method may further include obtaining the first periodic function corresponding to the first time interval from the external device through the communication interface and obtaining the second periodic function corresponding to the second time interval from the external device through the communication interface.

The control method may further include identifying whether there is an attack on the updated artificial intelligence model based on the pixel value change ratio of the image output from the updated artificial intelligence model.

In addition, the control method may further include additionally training, based on the artificial intelligence model being updated, the at least one layer having the activation function applied thereto, or additionally training all the layers included in the artificial intelligence model.

The electronic apparatus may be implemented as a low-capacity device in which the at least one layer included in the artificial intelligence model is not encrypted.

In addition, the control method may further include obtaining the first periodic function and the second periodic function based on the type of the artificial intelligence model, the type of the at least one layer, the type of the electronic apparatus, the user of the electronic apparatus, or the type of the activation function.

According to the various embodiments described above, the updated artificial intelligence model may be obtained by periodically updating the activation function of the artificial intelligence model, and applying the updated activation function to the artificial intelligence model. Accordingly, even without a large amount of data storage space, the security of the artificial intelligence model may be reinforced, the deterioration in processing rate may be prevented, and power efficiency may be increased.

The methods according to the various embodiments of the disclosure described above may be implemented in an application form installable in an electronic apparatus. Alternatively, the methods according to the various embodiments of the disclosure described above may be performed using a deep learning based neural network (or, deep trained neural network), that is, a learning network model. In addition, the methods according to the various embodiments of the disclosure described above may be implemented with only a software upgrade or a hardware upgrade of the electronic apparatus. In addition, the various embodiments of the disclosure described above may be performed through an embedded server provided in the electronic apparatus, or an external server of the electronic apparatus.

The various embodiments described above may be implemented with software including instructions stored in a machine-readable storage media (e.g., computer). The machine may call an instruction stored in the storage medium, and as a device operable according to the called instruction, may include an electronic apparatus (e.g., electronic apparatus A) according to the above-mentioned embodiments. Based on the instruction being executed by the processor, the processor may directly or using other elements under the control of the processor perform a function corresponding to the instruction. The instruction may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

According to an embodiment, the method according to the various embodiments described above may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product may be at least stored temporarily in a server of a manufacturer, a server of an application store, or a storage medium such as a memory of a relay server, or temporarily generated.

Each of the elements (e.g., a module or a program) according to the various embodiments described above may be formed as a single entity or a plurality of entities, and some sub-elements of the above-mentioned sub-elements may be omitted, or other sub-elements may be further included in the various embodiments. Alternatively or additionally, some elements (e.g., modules or programs) may be integrated into one entity to perform same or similar functions performed by each corresponding element prior to integration. Operations performed by a module, a program, or another element, in accordance with various embodiments, may be executed sequentially, in a parallel, repetitively, or in a heuristic manner, or at least some operations may be executed in a different order, omitted or a different operation may be added.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a memory storing an artificial intelligence model; and
at least one processor configured to:
identify a first activation function used in at least one layer of the artificial intelligence model,
obtain a second activation function by adding a first periodic function corresponding to a first time interval to the first activation function,
apply the second activation function to an output layer during the first time interval,
obtain a third activation function by adding a second periodic function corresponding to a second time interval to the first activation function, and
update the artificial intelligence model by applying the third activation function to the output layer during the second time interval.

2. The electronic apparatus of claim 1, wherein
each of the first periodic function and the second periodic function comprises functions added to a plurality of periodic functions,
wherein the first periodic function comprises at least one of a period of a function, an amplitude of a function, and a number of periodic functions, and
wherein the second periodic function comprises at least one of a period of a function, an amplitude of a function, and a number of periodic functions that is different from the first periodic function.

3. The electronic apparatus of claim 1, further comprising:
a communication interface,
wherein the at least one processor is further configured to:
obtain the first periodic function corresponding to the first time interval from an external device through the communication interface, and
obtain the second periodic function corresponding to the second time interval from the external device through the communication interface.

4. The electronic apparatus of claim 1, wherein the at least one processor is further configured to:
identify whether there is an attack on the updated artificial intelligence model based on a pixel value change rate of an image output from the updated artificial intelligence model.

5. The electronic apparatus of claim 1, wherein the at least one processor is further configured to update the artificial intelligence model by:
training the at least one layer having the second activation function or the third activation function applied thereto, or
additionally training all layers of the artificial intelligence model.

6. The electronic apparatus of claim 1, wherein the electronic apparatus is implemented as a low-capacity device in which the at least one layer of the artificial intelligence model is not encrypted.

7. The electronic apparatus of claim 1, wherein the at least one processor is further configured to:
obtain the first periodic function and the second periodic function based on a type of the artificial intelligence model, a type of the at least one layer, a type of the electronic apparatus, a user of the electronic apparatus, or a type of the first activation function.

8. The electronic apparatus of claim 1, wherein the at least one layer comprises the output layer.

9. The electronic apparatus of claim 1, wherein the first activation function comprises at least one of a continuous function and a discontinuous function.

10. A control method of an electronic apparatus, the method comprising:
identifying a first activation function used in at least one layer of an artificial intelligence model;
obtaining a second activation function by adding a first periodic function corresponding to a first time interval to the first activation function;
applying the second activation function to an output layer during the first time interval;
obtaining a third activation function by adding a second periodic function corresponding to a second time interval to the first activation function; and
updating the artificial intelligence model by applying the third activation function to the output layer during the second time interval.

11. The method of claim 10, wherein each of the first periodic function and the second periodic function comprises functions added to a plurality of periodic functions,
wherein the first periodic function comprises at least one of a period of a function, an amplitude of a function, and a number of periodic functions, and
wherein the second periodic function comprises at least one of a period of a function, an amplitude of a function, and a number of periodic functions that is different from the first periodic function.

12. The method of claim 10, further comprising:
obtaining the first periodic function corresponding to the first time interval from an external device through a communication interface; and
obtaining the second periodic function corresponding to the second time interval from the external device through the communication interface.

13. The method of claim 10, further comprising:
identifying whether there is an attack on the updated artificial intelligence model based on a pixel value change ratio of an image output from the updated artificial intelligence model.

14. The method of claim 10, further comprising:
based on the artificial intelligence model being updated, training the at least one layer having the second activation function or the third activation function applied thereto, or
additionally training all layers of the artificial intelligence model.

15. The method of claim 10, wherein the electronic apparatus is implemented as a low-capacity device in which the at least one layer of the artificial intelligence model is not encrypted.

16. The method of claim 10, further comprising:
obtaining the first periodic function and the second periodic function based on a type of the artificial intelligence model, a type of the at least one layer, a type of the electronic apparatus, a user of the electronic apparatus, or a type of the first activation function.

17. The method of claim 10, wherein the at least one layer comprises the output layer.

18. The method of claim 10, wherein the first activation function comprises at least one of a continuous function and a discontinuous function.

19. A non-transitory computer-readable storage medium storing instructions that, when executed by a processor of an electronic apparatus, cause the processor to:
identify a first activation function used in at least one layer of an artificial intelligence model;
obtain a second activation function by adding a first periodic function corresponding to a first time interval to the first activation function;
apply the second activation function to an output layer during the first time interval;
obtain a third activation function by adding a second periodic function corresponding to a second time interval to the first activation function; and
update the artificial intelligence model by applying the third activation function to the output layer during the second time interval.
